(19) United States
(12) Patent Application Publication
(10) Pub. No.: US 2023/0344554 A1
(43) Pub. Date: Oct. 26, 2023

(54) ACCESS LAYER IP PACKET PROCESSING METHOD, APPARATUS AND DEVICE

(71) Applicants: CHINA MOBILE COMMUNICATION CO., LTD RESEARCH INSTITUTE, Beijing (CN); CHINA MOBILE COMMUNICATIONS GROUP CO., LTD., Beijing (CN)

(72) Inventor: Junshuai SUN, Beijing (CN)

(21) Appl. No.: 17/796,394

(22) PCT Filed: Jan. 14, 2021
(86) PCT No.: PCT/CN2021/071738

§ 371 Date: Sep. 13, 2022

(30) Foreign Application Priority Data
Feb. 3, 2020 (CN) 202010078494.0

(51) Int. Cl. H04L 1/08; H04W 76/12; H04W 76/22; H04W 76/32

(52) U.S. Cl. CPC H04L 1/08; H04W 76/12; H04W 76/22; H04W 76/32

(57) ABSTRACT

Provided are an access layer IP packet processing method, apparatus and device. The access layer IP packet processing method is applied to a user plane function entity at layer 3 of an access layer. The method comprises: a user plane function entity at layer 3 of an access layer receiving an IP packet from an IP packet entity, and sending same to at least one function entity at layer 2 of the access layer; or receiving a data packet or a control packet sent by the function entity at layer 2 of the access layer, and sending same to the IP packet entity, wherein the user plane function entity at layer 3 of the access layer, the IP packet entity and the function entity at layer 2 of the access layer are function entities of a terminal side or function entities of a network device.

### CROSS-REFERENCE TO RELATED APPLICATION

The present application claims priority of Chinese Application No. 202010078494.0, filed on Feb. 3, 2020, the contents of which are hereby incorporated by reference in its entirety.

### TECHNICAL FIELD

The present disclosure relates to the technical filed of communication, and in particular to a method, apparatus and device for Internet Protocol (IP) packet processing in an Access Stratum.

### BACKGROUND

Simply speaking, Self-consistency means that if we deduce according to our own logic, we can prove that we are at least not contradictory or wrong, which is simple self-consistency. Scientific research itself follows self-consistency and is built on an objective basis. Otherwise, it is built on a subjective basis, and the final attribution cannot be falsified or proven. A theory or method that cannot satisfy self-consistency is obviously self-defeating.

The concept of Native Artificial Intelligence (AI) is widely mentioned. AI tools are used in the wireless network to optimize wireless resources of the wireless network. The next-generation wireless network faces more complex application scenarios. If AI tools can be used to better serve users, the user experience can be greatly improved.

The protocol stack of the fifth Generation (5G) wireless access network realizes the matching of logical channel (service) and air interface resources through the scheduling of Media Access Control (MAC). However, the priority and the Quality of Service (QoS) guarantee parameters of the logical channel are all formulated by the upper layer (core network), and the air interface wireless quality where the logical channel (service) is located is not considered when formulating the priority and the QoS guarantee parameters.

In the 5G wireless access network, when the data of Layer 2 (L2) fails to be sent, retransmission is performed by using the Transmission Control Protocol (TCP)/IP layer which is the upper layer, which will lead to rapid narrowing of the TCP transmission window and a greater delay of retransmission of data packets. Moreover, the problem of matching the control of the TCP transmission window with the transmission in the lower layer has also been studied for many years. Retransmission and transmission window can be controlled according to the channel quality of the lower layer through TCP.

The design goal of Lite Network for the next generation mobile communication needs to be redesigned in this way.

The data processing plane of the protocol stack of 5G Access Stratum (AS) in the related art still adopts the data processing method in the related art, i.e. L2 is responsible for data processing through an air interface link and has no interaction with the TCP/IP layer.

### SUMMARY

The present disclosure provides a method, apparatus and device for IP packet processing in the Access Stratum, thereby realizing the processing of the IP packet in the Access Stratum.

To solve the above technical problem, embodiments of the present disclosure provide the following solution.

A method for Internet Protocol (IP) packet processing in the Access Stratum (AS), which is applied to a User Plane Function (UPF) entity of Layer 3 of the AS, includes the following operations.

The UPF entity of the Layer 3 of the AS receives one or more IP packets from an IP packet entity and sends the IP packets to at least one function entity of Layer 2 of the AS. Alternatively, the UPF entity of the Layer 3 of the AS receives data packets or control packets from the function entity of the Layer 2 of the AS and sends the data packets or the controls packet to the IP packet entity. Herein the UPF entity of the Layer 3 of the AS, the IP packet entity and the function entity of the Layer 2 of the AS are function entities at a user equipment (UE) side or function entities at a network device side.

In an embodiment, the method for IP packet processing in the AS further includes that the UPF entity of the Layer 3 of the AS resends the IP packets in response to failure of sending or reception of the IP packets.

In an embodiment, the method for IP packet processing in the AS further includes that the UPF entity of the Layer 3 of the AS sorts the data packets received from the function entity of the Layer 2 of the AS and sends the sorted IP packets to the IP packet entity.

In an embodiment, the UPF entity of the Layer 3 of the AS includes a source UPF entity of the Layer 3 of the AS and a destination UPF entity of the Layer 3 of the AS.

The method further includes that the source UPF entity sends the IP packets to the IP packet entity, so as to send the IP packets to the destination UPF entity through the IP packet entity.

In an embodiment, the IP packet entity is in communication connection with one or more UPF entities, and the IP packet entity distributes the IP packets to the one or more UPF entities.

The method further includes that multiple UPF entities receives the IP packets distributed by the IP packet entity.

In an embodiment, the IP packet entity establishes, modifies or releases the UPF entity corresponding to a control plane function entity of the Layer 3 through the control plane function entity. The method further includes that the UPF entity receives a request for establishing, modifying or releasing an IP connection from the control plane function entity corresponding to the UPF entity.

The UPF entity establishes modifies or releases IP connections with the IP packet entity and the at least one function entity of Layer 2 of the AS according to the request for establishing, modifying or releasing the IP connection.

In an embodiment, the method for the IP packet processing further includes that a control plane function entity at the UE side receives a signaling for IP connection establishment, a signaling for IP connection modification or a signaling for IP connection release from a control plane function entity at the network device side. Alternatively, the control plane function entity at the UE side send a request signaling for the IP connection establishment, a request signaling for the IP connection modification or a request signaling for the IP connection release to the control plane function entity at the network device side.

Embodiments of the present disclosure further provide an apparatus for Internet Protocol (IP) packet processing in an Access Stratum (AS). The apparatus is applied to a User Plane Function (UPF) entity of Layer 3 of the AS and includes a transceiver module.

The transceiver module is configured to receive one or more IP packets from an IP packet entity and send the IP packets to at least one function entity of Layer 2 of the AS, or receive data packets or control packets from the function entity of the Layer 2 of the AS and send the data packets or the control packets to the IP packet entity. Herein the UPF entity of the Layer 3 of the AS, the IP packet entity and the function entity of the Layer 2 of the AS are function entities at a user equipment (UE) side or function entities at a network device side.

In an embodiment, the transceiver module of the apparatus for IP packet processing in the AS is further configured to resend the IP packets in response to failure of sending or reception of the IP packets.

In an embodiment, the transceiver module is further configured to sort the data packets received from the function entity of the Layer 2 of the AS and send the sorted IP packets to the IP packet entity.

In an embodiment, the UPF entity of the Layer 3 of the AS includes a source UPF entity of the Layer 3 of the AS and a destination UPF entity of the Layer 3 of the AS. A transceiver module of the source UPF entity is configured to send the IP packets to the IP packet entity, so as to send the IP packets to a transceiver module of the destination UPF entity through the IP packet entity.

In an embodiment, the IP packet entity is in communication connection with one or more UPF entities, and the IP packet entity distributes the IP packets to the one or more UPF entities.

Transceiver modules of multiple UPF entities are configured to receive the IP packets distributed by the IP packet entity.

In an embodiment, the IP packet entity establishes, modifies or releases the UPF entity corresponding to a control plane function entity of the Layer 3 through the control plane function entity.

The transceiver module is further configured to receive a signaling for IP connection establishment, a signaling for IP connection modification or a signaling for IP connection release from the control plane function entity corresponding to the UPF entity, and establish, modify or release IP connections with the IP packet entity and the at least one function entity of Layer 2 of the AS according to the signaling for IP connection establishment, the signaling for IP connection modification or the signaling for IP connection release.

Embodiments of the present disclosure further provide a communication device including a transceiver.

The transceiver is configured to receive one or more IP packets from an IP packet entity and send the IP packets to at least one function entity of Layer 2 of the AS, or receive data packets or control packets from the function entity of the Layer 2 of the AS and send the data packets or the control packets to the IP packet entity. Herein the UPF entity of the Layer 3 of the AS, the IP packet entity and the function entity of the Layer 2 of the AS are function entities of the communication device, and the communication device is a user equipment or a network device.

Embodiments of the present disclosure also provide a communication device including a processor, a memory storing a computer program. When the computer program is executed by the processor, the above-mentioned methods are performed.

Embodiments of the present disclosure also provide a computer-readable storage medium including instructions. When the instructions are executed by a computer, the above-mentioned methods are performed by the computer.

The above mentioned embodiments of the present disclosure include at least the following technical effects.

According to the above mentioned embodiments of the present disclosure, the UPF entity of the Layer 3 of the AS receives one or more IP packets from an IP packet entity and sends the IP packets to at least one function entity of Layer 2 of the AS, or receives data packets or control packets from the function entity of the Layer 2 of the AS and sends the data packets or the control packets to the IP packet entity, so as to realize the IP packet processing in the AS.

### BRIEF DESCRIPTION OF THE DRAWINGS

FIG. 1 illustrates a flowchart of a method for IP packet processing in an Access Stratum according to an embodiment of the present disclosure.

FIG. 2 illustrates a diagram of the network architecture of the connection between the user equipment side and the network side according to an embodiment of the present disclosure.

FIG. 3 illustrates a flowchart of IP connection establishment according to an embodiment of the present disclosure.

FIG. 4 illustrates a block diagram of an apparatus for IP packet processing in an Access Stratum according to an embodiment of the present disclosure.

FIG. 5 illustrates a diagram of the architecture of a communication device according to an embodiment of the present disclosure.

### DETAILED DESCRIPTION

Exemplary embodiments of the present disclosure will be described in more detail below with reference to the drawings. While exemplary embodiments of the present disclosure are illustrated in the drawings, it should be understood that the disclosure may be implemented in various forms without being limited by the embodiments set forth herein. Rather, these embodiments are provided to enable a more thorough understanding of the disclosure and to enable the full scope of the disclosure to be communicated to those skilled in the art.

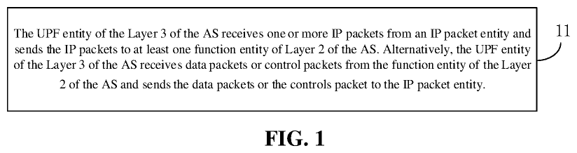

As illustrated in FIG. 1, embodiments of the present disclosure provide a method for Internet Protocol (IP) packet processing in the Access Stratum (AS), which is applied to a User Plane Function (UPF) entity of Layer 3 (L3) of the AS. The method includes the following operations.

At block 11, the UPF entity of the Layer 3 of the AS receives one or more IP packets from an IP packet entity and sends the IP packets to at least one function entity of Layer 2 (L2) of the AS. Alternatively, the UPF entity of the Layer 3 of the AS receives data packets or control packets from the function entity of the Layer 2 of the AS and sends the data packets or the controls packet to the IP packet entity. Herein the UPF entity of the Layer 3 of the AS, the IP packet entity and the function entity of the Layer 2 of the AS are function entities at a user equipment (UE) side or function entities at a network device side.

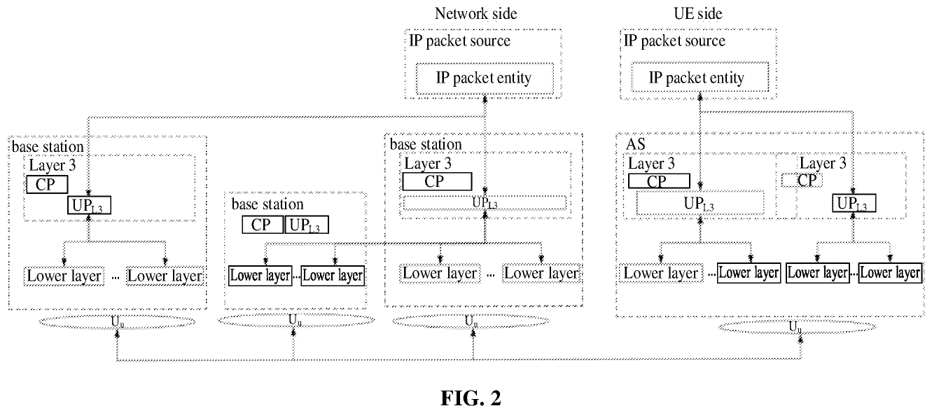

As illustrated in FIG. 2, the IP packet entity herein can be the IP packet entity at the UE side or the network device side, which refers to the function entity capable of sending the IP packets to or receiving the IP packets from the L2 of the AS. The IP packet entity can be an IP layer protocol entity at the UE side or the network device side, a gateway function entity at the UE side or the network device side, a UPF entity of core network at the network side, a firewall function entity of core network at the network side, or the like.

Here, the UPF entity of the Layer 3 of the AS can be UP_{L3}, which is an IP function entity located in the AS and is a general term for the functions of Distributed IP function related to data processing in the AS deployed near the air interface. Because the IP layer is in L3 in the seven-layer model of the International Standardization Organization (ISO), it refers to the data plane functions related to the IP layer that sink to the AS layer here.

In an optional embodiment of the present disclosure, the method for IP packet processing in the AS further includes the following operation.

At block 12, the UPF entity of the Layer 3 of the AS retransmits the IP packets in response to failure of sending or reception of the IP packets.

In the embodiment, the data retransmission function of the UPF entity UP_{L3} of the Layer 3 of the AS at the UE side or the network device side is to ensure that for the data transmission in the lower layers, after the data transmission fails, the retransmission is not required at the Transmission Control Protocol (TCP) layer, and instead, is directly performed at the UPF entity UP_{L3} of the Layer 3 of the AS, thereby reducing the influence on the TCP transmission window and shortening the delay required on the link during data transmission.

In the embodiment, the data retransmission function of the UPF entity UP_{L3} of the Layer 3 of the AS shields the retransmission of the links in the lower layer and ensures that the upper layer is not aware of the data retransmission in the lower layer. No matter how many retransmissions are performed in the UP_{L3} or its links in the lower layer, or even the links in the lower layer are reconstructed because the number of retransmissions exceeds the specified threshold, the data for each retransmission is only obtained from the UP_{L3}, and there is no need to apply for the data to the upper layer of UP_{L3}, which means that the UP_{L3} has the function of retransmission or the function of data buffering until the transmission in the lower layer is successful. If the UP_{L3} has the function of retransmission, the retransmission of the data packets is initiated after the transmission failure in the lower layer is monitored. This function requires UP_{L3} to have the function of monitoring the transmission failure of the data packets in the lower layer. For example, the UP_{L3} receives the data reception status information from the peer UP_{L3} function entity and determines whether the data packets need to be resent according to the feedback information. If the UP_{L3} has the function of ensuring the correct transmission of data, the UP_{L3} caches each of the data packets sent to the lower layer locally. When the transmission in the lower layer is successful, the UP_{L3} is informed that the corresponding data has been successfully sent and releases the corresponding data packet in the cache. After the transmission in the lower layer is failed, the UP_{L3} is informed that the corresponding data packets are not successfully sent and need to be resent. For these data packets that are not successfully sent, the UP_{L3} can send the data packets through the original link in the lower layer or through other available links. When the UP_{L3} sends these data packets, it sends these data packets in the way of sending new data. In any way, the data packets cached by UP_{L3} will not be discarded until the transmission in the lower layer is successful, otherwise, the data packets will support the links of the lower layer for transmission, thereby ensuring that the IP packet entity is not aware of the retransmission of the links in the lower layer.

In an optional embodiment of the present disclosure, the method for IP packet processing in the AS further includes the following operation.

At block 13, the UPF entity of the Layer 3 of the AS sorts the data packets received from the function entity of the Layer 2 of the AS and sends the sorted IP packets to the IP packet entity.

In the embodiment, the sorting function of the UPF entity UP_{L3} of the Layer 3 of the AS at the UE side or the network device side is to ensure that the UPF can submit the data packets to the upper layer in sequence when the UPF entity receives the data packets from the lower layer and sends the data packets to the IP packet entity.

When an IP packet entity is connected to one or more UP_{L3} at the same time, the IP packet entity can send the data received from the one or more UP_{L3} to the upper layer in sequence upon the reception of data. For the transmission of the data, the IP packet entity can distribute the data to the one or more UP_{L3} in sequence.

When a UP_{L3} is connected to function units or function entities of one or more lower layers at the same time, the UP_{L3} can send data received from the multiple lower layers to the IP packet entity in sequence upon the reception of data.

UP_{L3} cannot send the data packets out of order to the IP packet entity. For the transmission of the data, the UP_{L3} can distribute the data to one or more lower layers in sequence. The UP_{L3} can itself have data packet identifiers for receiving and sending data packets in sequence, such as the Sequence Number (SN) of data packets defined by UP_{L3} itself. The UP_{L3} can use the data packet identifiers from the lower layer for receiving and sending data packets in sequence, such as using the SN provided by protocol entities of the L2 (for example, the PDCP layer assigns each data packet a respective SN).

In an optional embodiment of the present disclosure, the UPF entity of the Layer 3 of the AS includes a source UPF entity of the Layer 3 of the AS and a destination UPF entity of the Layer 3 of the AS. The method for IP packet processing in the AS further includes the following operation.

At block 14, the source UPF entity sends the IP packets to the IP packet entity, so as to send the IP packets to the destination UPF entity through the IP packet entity.

In this embodiment, when the handover between the source UP_{L3} and the destination UP_{L3} occurs during the movement of the UE, the IP packet entity has the function of assisting the source UP_{L3} and the destination UP_{L3} to realize data forwarding.

There is a process of interaction between the IP packet entity and the UP_{L3} for receiving and sending data packets. The IP packet entity caches the data packets sent to the UP_{L3}. When the transmission in the UP_{L3} is successful, the IP packet entity is informed to discard the cached data packets.

Alternatively, the IP packet entity does not cache the data packets sent to the UP_{L3}. When data forwarding is required, the data forwarding interaction between the IP packet entity and each UP_{L3} includes that the IP packet entity indicates the data interaction between the source UP_{L3} and the destination UP_{L3}. Alternatively, the source UP_{L3} may first report the data packets to be forwarded or the identity indication information of the data packets (the IP packet entity caches these data) to the IP packet entity, and then the IP packet entity sends the data packets to the destination UP_{L3}.

In an optional embodiment of the present disclosure, the IP packet entity is in communication connection with one or more UPF entities, and the IP packet entity distributes the IP packets to the one or more UPF entities. The method for IP packet processing in the AS further includes the following operation.

At block 15, multiple UPF entities receives the IP packets distributed by the IP packet entity

In the embodiment, when one IP packet entity is connected to one or more UP_{L3} at the same time, the IP packet entity can distribute the data to multiple UP_{L3} at the same time during the transmission of data, and the IP packet entity has the flow control function. When one UP_{L3} is connected to one or more lower layers at the same time, the UP_{L3} can distribute the data to multiple lower layers at the same time during the transmission of data, and the UP_{L3} has the flow control function.

In an optional embodiment of the present disclosure, the IP packet entity establishes, modifies or releases the UPF entity corresponding to a control plane function entity of the Layer 3 through the control plane function entity. The method for IP packet processing in the AS further includes the following operations.

At block 16, the UPF entity receives a signaling for IP connection establishment, a signaling for IP connection modification or a signaling for IP connection release from the control plane function entity corresponding to the UPF entity.

At block 17, the UPF entity establishes, modifies or releases IP connections with the IP packet entity and the at least one function entity of Layer 2 of the AS according to the signaling for IP connection establishment, the signaling for IP connection modification or the signaling for IP connection release.

In this embodiment, the IP packet entity can control the establishment, modification or release of the UP_{L3}. The IP packet entity can have the direct control function and can trigger the Control Plane (CP) to generate end-to-end signaling to establish UP_{L3}.

Optionally, the method for IP packet processing in the AS further includes that a control plane function entity at the UE side receives a signaling for IP connection establishment, a signaling for IP connection modification or a signaling for IP connection release from a control plane function entity at the network device side.

Alternatively, the control plane function entity at the UE side sends a request signaling for the IP connection establishment, a request signaling for the IP connection modification or a request signaling for the IP connection release to the control plane function entity at the network device side.

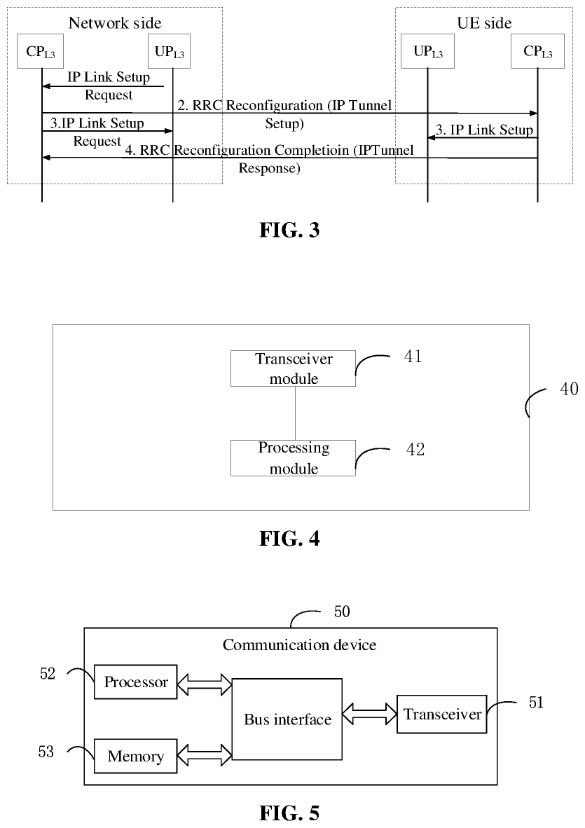

As illustrated in FIG. 3, in the embodiment, the control plane function entity at the UE side and the control plane function entity at the network device side interact to establish or release the IP connection, which includes the following operations.

At block 31, the UP_{L3} at the UE side generates an IP Link Setup Request according to the parsed IP information. The IP Link Setup Request carries a source IP address of the IP flow, a destination IP address of the IP flow and an identity information of the IP flow.

At block 32, after receiving the request, the control plane function entity at the network device CP_{L3} configures the UE through the Radio Resource Control (RRC) Reconfiguration (IP Tunnel Setup) signaling. The signaling carries the information related to IP tunnel configuration, which includes the source IP address, the destination IP address, the lower layer bearer information bearing the IP flow (e.g. identity information of the lower layer bearer, QoS related parameters of the lower layer bearer, the mapping information between the lower layer bearer and the IP flow, etc.).

At block 33, the UE side and the network side configure their respective UP_{L3} functions after completing the air interface RRC Reconfiguration signaling.

At block 34, the UE side sends a response message to the network side after completing the configuration.

In the above embodiments of the present disclosure, as illustrated in FIG. 2, for an end-to-end link of a UE, both the UE side and the network side have one or more peer-to-peer IP packet entities. In order to be peer-to-peer with the network side, the UE side needs a UP_{L3} function entity having the same function as the network side connected to the UE.

In the system architecture illustrated in FIG. 2, the UE is connected to two independent network devices (e.g. base stations) at the same time, and each independent base station has an UP_{L3} function entity. At this time, the UE side can establish two independent UP_{L3} function entities or one UP_{L3} function entity. At the same time, because of the flexibility of the forms of the base stations at the network side, the link connecting the same UE can adopt the mode of one primary base station connecting multiple secondary base stations at the same time. At this time, the link of the UE on the secondary base station is connected to the UP_{L3} function entity of the primary base station. Therefore, the UE side only needs one UP_{L3} function entity at this time.

After accessing the network device, the UE establishes the corresponding UP_{L3} function according to the signaling from the network device, which includes the connection between the IP packet entity and the UP_{L3}, and the connection between the UP_{L3} and the link of lower layer. The UE establishes multiple UP_{L3} function entities, which indicates that there are multiple links of upper layer between the UE side and the network side. When the UE establishes only one UP_{L3} function entity, it indicates that there is only one upper-layer link between the UE side and the network side. The UP_{L3} function entity is connected to multiple function entities in the lower layer, which indicates that there are multiple lower-layer links between the UE side and the network side.

For the network side, if the entire TCP/IP is sunk to the AS, the data routing range of TCP/IP layer is reduced. In other words, data routing can only be carried out within one AS, and a large amount of data forwarding will be caused during handover. If the TCP/IP is deployed close to AS, the link will be shortened, thereby reducing the length of Round Trip Time (RTT) and shortening the delay of data transmission and retransmission.

In the above embodiment of the present disclosure, a distributed IP function and an IP function of AS are provided, which are oriented to Native AI. The functions can reconstruct the User Plane (UP) of the wireless access network, thereby realizing the integration of L3 and L2.

As illustrated in FIG. 4, embodiments of the present disclosure provide an apparatus 40 for Internet Protocol (IP) packet processing in the Access Stratum (AS), which is applied to a User Plane Function (UPF) entity of Layer 3 (L3) of the AS. The apparatus includes a transceiver module 41.

The transceiver module 41 is configured to receive one or more IP packets from an IP packet entity and send the IP packets to at least one function entity of Layer 2 of the AS, or receive data packets or control packets from the function entity of the Layer 2 of the AS and send the data packets or the control packets to the IP packet entity. Herein, the UPF entity of the Layer 3 of the AS, the IP packet entity and the function entity of the Layer 2 of the AS are function entities at a user equipment (UE) side or function entities at a network device side.

Optionally, the transceiver module 41 is further configured to resend the IP packets in response to failure of sending or reception of the IP packets.

Optionally, the transceiver module 41 is further configured to sort the data packets received from the function entity of the Layer 2 of the AS and send the sorted IP packets to the IP packet entity.

Optionally, the UPF entity of the Layer 3 of the AS includes a source UPF entity of the Layer 3 of the AS and a destination UPF entity of the Layer 3 of the AS. A transceiver module of the source UPF entity is configured to send the IP packets to the IP packet entity, so as to send the IP packets to a transceiver module of the destination UPF entity through the IP packet entity.

Optionally, the IP packet entity is in communication connection with one or more UPF entities, and the IP packet entity distributes the IP packets to the one or more UPF entities.

Transceiver modules 41 of multiple UPF entities are configured to receive the IP packets distributed by the IP packet entity.

Optionally, the IP packet entity establishes, modifies or releases the UPF entity corresponding to a control plane function entity of the Layer 3 through the control plane function entity.

The transceiver module 41 is further configured to receive a signaling for IP connection establishment, a signaling for IP connection modification or a signaling for IP connection release from the control plane function entity corresponding to the UPF entity, and establish, modify or release an IP connection with the IP packet entity and the at least one function entity of Layer 2 of the AS according to the signaling for IP connection establishment, the signaling for IP connection modification or the signaling for IP connection release.

It should be noted that the apparatus is corresponding to the method illustrated in FIG. 1. All the implementation modes in the method embodiments are applicable to the apparatus embodiments with the same technical effect. The apparatus may further include a processing module 42 for processing the data sent and received by the transceiver module 41, and the like.

As illustrated in FIG. 5, embodiments of the present disclosure also provide a communication device 50, which includes a transceiver 51.

The transceiver 51 is configured to receive one or more IP packets from an IP packet entity and send the IP packets to at least one function entity of Layer 2 of the AS, or receive data packets or control packets from the function entity of the Layer 2 of the AS and send the data packets or the control packets to the IP packet entity. Herein the UPF entity of the Layer 3 of the AS, the IP packet entity and the function entity of the Layer 2 of the AS are function entities of the communication device, and the communication device is a user equipment or a network device.

Optionally, the transceiver 51 is further configured to resend the IP packets in response to failure of sending or reception of the IP packets.

Optionally, the transceiver 51 is further configured to sort the data packets received from the function entity of the Layer 2 of the AS and send the sorted IP packets to the IP packet entity.

Optionally, the UPF entity of the Layer 3 of the AS includes a source UPF entity of the Layer 3 of the AS and a destination UPF entity of the Layer 3 of the AS. A transceiver module of the source UPF entity is configured to send the IP packets to the IP packet entity, so as to send the IP packets to a transceiver module of the destination UPF entity through the IP packet entity.

Optionally, the IP packet entity is in communication connection with one or more UPF entities, and the IP packet entity distributes the IP packets to the one or more UPF entities.

Transceivers 51 of multiple UPF entities are configured to receive the IP packets distributed by the IP packet entity.

Optionally, the IP packet entity establishes, modifies or releases the UPF entity corresponding to a control plane function entity of the Layer 3 through the control plane function entity.

The transceiver 51 is further configured to receive a signaling for IP connection establishment, a signaling for IP connection modification or a signaling for IP connection release from the control plane function entity corresponding to the UPF entity, and establish, modify or release an IP connection with the IP packet entity and the at least one function entity of Layer 2 of the AS according to the signaling for IP connection establishment, the signaling for IP connection modification or the signaling for IP connection release.

It should be noted that the communication device is corresponding to the methods illustrated in FIG. 1. All the implementation modes in the method embodiments are applicable to the device embodiments with the same technical effect. The communication device may further include a processor 52 and a memory 53. The transceiver 51 and the processor 52, as well as the transceiver 51 and the memory 53, can be connected through a bus interface. The functions of the transceiver 51 can be realized by the processor 52, and the functions of the processor 52 can also be realized by the transceiver 51.

Embodiments of the present disclosure also provide a communication device including a processor and a memory that stores a computer program. When the computer program is executed by the processor, the method described in FIG. 1 is executed.

Embodiments of the present disclosure further provide a computer-readable storage medium including instructions that, when executed by the computer, cause the computer to perform the method described in FIG. 1.

Those skilled in the art will appreciate that the units and algorithm steps of various examples described in connection with the embodiments of the present disclosure can be implemented in electronic hardware or in a combination of computer software and electronic hardware. Whether these units and algorithm steps are performed in hardware or in software depends on the specific application and design constraints of the technical solutions. Those skilled in the art may use different methods for different specific application to implement the described functionality, but such implementation should not be considered beyond the scope of the present disclosure.

Those skilled in the art will clearly appreciate that for convenience and conciseness of description, the specific operating processes of the above-mentioned systems, devices and units may refer to the corresponding processes in the aforementioned method embodiments and will not be repeated herein.

In the embodiments provided herein it should be understood that the disclosed devices and methods may be implemented in other ways. For example, the above-mentioned embodiments of the device are only schematic. For example, the division of the unit is only a logical functional division, and in practice, there may be another division manner. For example, multiple units or components may be combined or integrated into another system, or some features may be ignored or not performed. On the other hand, the coupling or direct coupling or communication connection between each other illustrated or discussed may be indirect coupling or communication connection through some interface, device or unit, and may be electrical, mechanical or other forms.

The units illustrated as separate elements may or may not be physically separated, and the elements displayed as units may or may not be physical units, i.e., they may be located in one place, or may be distributed over multiple network units. Some or all of the units may be selected according to actual needs to achieve the objectives of the embodiments of the present disclosure.

In addition, the functional units in various embodiments of the present disclosure may be integrated in one processing unit, or each unit may exist physically individually, or two or more units may be integrated in one unit.

The functions may be stored in a computer-readable storage medium if implemented in form of software functional units and sold or used as stand-alone products. Based on such an understanding, the essence of the technical solutions of the present disclosure, or the part that contributes to the related technologies, or part of the technical solutions can be embodied in the form of a software product stored in a storage medium including several instructions, which can be executed by a computer device (which may be a personal computer, a server, or a network device, etc.) to implement all or part of the operations of the method described in the various embodiments of the present disclosure. The foregoing storage medium includes a Universal Serial Bus (USB) flash drive, a removable hard disk, a Read-Only Memory (ROM), a Random Access Memory (RAM), a magnetic disk, an optical disk, or any other medium that can store program code.

Those skilled in the art will appreciate that all or part of the processes of the above-mentioned method embodiments can be accomplished by controlling the related hardware through a computer program. The program can be stored in a computer readable storage medium, and the program, when executed, can include the processes of the above-mentioned method embodiments. The storage medium can be a magnetic disk, an optical disk, a Read-Only Memory (ROM) or a Random Access Memory (RAM), etc.

It can be understood that the embodiments described herein can be implemented through hardware, software, firmware, middleware, microcode, or combinations thereof. For hardware implementation, modules, units and sub units can be implemented in one or more Application Specific Integrated Circuits (ASIC), Digital Signal Processors (DSP), Digital Signal Processing Devices (DSPD), Programmable Logic Devices (PLD), Field-Programmable Gate Arrays (FPGA), general purpose processors, controllers, microcontrollers, microprocessors, other electronic units for performing the functions described herein, or combinations thereof.

For software implementation, the techniques described in the embodiments of the present disclosure can be realized by modules (e.g. procedures, functions, etc.) that perform the functions described in the embodiments of the present disclosure. The software code may be stored in a memory and executed by a processor. The memory may be implemented in the processor or outside the processor.

Furthermore, it should be noted that the components or steps of the apparatus and method of the present disclosure can be decomposed and/or recombined. These decompositions and/or re-combinations should be regarded as equivalent solutions of the present disclosure. Moreover, the steps for executing the above-described series of processes may naturally be executed in chronological order in the order described, but may not necessarily be executed in chronological order, and certain steps may be executed in parallel or independently of each other. Those skilled in the art can understand that all or any steps or components of the method and apparatus disclosed herein can be implemented by hardware, firmware, software, or combinations thereof in any computing device (including a processor, a storage medium, etc.) or in the network of computing devices. This can be achieved by those skilled in the art using their basic programming skills after reading the description of the present disclosure.

Therefore, the subject matter of the present disclosure can also be realized by running a program or a set of programs on any computing device. The computing device may be a well-known general-purpose device. Therefore, the subject matter of the present disclosure may also be realized only by providing a program product including program code for implementing the method or apparatus. In other words, such a program product also constitutes the present disclosure, and a storage medium storing such a program product also constitutes the present disclosure. Obviously, the storage medium may be any known storage medium or any storage medium developed in the future. It should also be noted that in the apparatus and method of the present disclosure, it is obvious that the components or steps can be decomposed and/or recombined. These decompositions and/or recombinations should be regarded as equivalent solutions of the present disclosure. Moreover, the steps for executing the above-described series of processes may naturally be executed in chronological order in the order described, but may not necessarily be executed in chronological order, and certain steps may be executed in parallel or independently of each other.

Those described above are alternative embodiments of the present disclosure. It should be pointed out that, for those skilled in the art, several improvements and refinements can be made without departing from the principles of the present disclosure, and these improvements and refinements should also be considered within the scope of protection of the present disclosure.

1. A method for Internet Protocol (IP) packet processing in an Access Stratum (AS), applied to a User Plane Function (UPF) entity of Layer 3 of the AS, comprising:
receiving, by the UPF entity of the Layer 3 of the AS, one or more IP packets from an IP packet entity and sending the IP packets to at least one function entity of Layer 2 of the AS; or
receiving, by the UPF entity of the Layer 3 of the AS, data packets or control packets from the function entity of the Layer 2 of the AS, and sending the data packets or the controls packet to the IP packet entity,
wherein the UPF entity of the Layer 3 of the AS, the IP packet entity and the function entity of the Layer 2 of the AS are function entities at a user equipment (UE) side or function entities at a network device side.

2. The method for the IP packet processing in the AS of claim 1, further comprising:
in response to failure of sending or reception of the IP packets, resending, by the UPF entity of the Layer 3 of the AS, the IP packets.

3. The method for the IP packet processing in the AS of claim 1, further comprising:
sorting, by the UPF entity of the Layer 3 of the AS, the data packets received from the function entity of the Layer 2 of the AS and sending the sorted IP packets to the IP packet entity.

4. The method for the IP packet processing in the AS of claim 1, wherein the UPF entity of the Layer 3 of the AS comprises a source UPF entity of the Layer 3 of the AS and a destination UPF entity of the Layer 3 of the AS, and
wherein the method further comprises:
sending, by the source UPF entity, the IP packets to the IP packet entity, so as to send the IP packets to the destination UPF entity through the IP packet entity.

5. The method for the IP packet processing in the AS of claim 1, wherein the IP packet entity is in communication connection with one or more UPF entities, and the IP packet entity distributes the IP packets to the one or more UPF entities,
wherein the method further comprises:
receiving, by the one or more UPF entities, the IP packets distributed by the IP packet entity.

6. The method for the IP packet processing in the AS of claim 1, wherein the IP packet entity establishes, modifies or releases the UPF entity corresponding to a control plane function entity of the Layer 3 through the control plane function entity,
wherein the method further comprises:
receiving, by the UPF entity, a request for establishing, modifying or releasing an IP connection from the control plane function entity corresponding to the UPF entity; and
establishing, modifying or releasing, by the UPF entity, IP connections with the IP packet entity and the at least one function entity of Layer 2 of the AS according to the request for establishing, modifying or releasing the IP connection.

7. The method for the IP packet processing in the AS of claim 6, further comprising:
receiving, by a control plane function entity at the UE side, a signaling for IP connection establishment, a signaling for IP connection modification or a signaling for IP connection release from a control plane function entity at the network device side; or
sending, by the control plane function entity at the UE side, a request signaling for the IP connection establishment, a request signaling for the IP connection modification or a request signaling for the IP connection release to the control plane function entity at the network device side.

8. An apparatus for Internet Protocol (IP) packet processing in an Access Stratum (AS), applied to a User Plane Function (UPF) entity of Layer 3 of the AS, comprising:
a transceiver, configured to receive one or more IP packets from an IP packet entity and send the IP packets to at least one function entity of Layer 2 of the AS, or receive data packets or control packets from the function entity of the Layer 2 of the AS and send the data packets or the control packets to the IP packet entity,
wherein the UPF entity of the Layer 3 of the AS, the IP packet entity and the function entity of the Layer 2 of the AS are function entities at a user equipment (UE) side or function entities at a network device side.

9. The apparatus for the IP packet processing in the AS of claim 8, wherein,
the transceiver is further configured to resend the IP packets in response to failure of sending or reception of the IP packets.

10. The apparatus for the IP packet processing in the AS of claim 8, wherein,
the transceiver is further configured to sort the data packets received from the function entity of the Layer 2 of the AS and send the sorted IP packets to the IP packet entity.

11. The apparatus for the IP packet processing in the AS of claim 8, wherein the UPF entity of the Layer 3 of the AS comprises a source UPF entity of the Layer 3 of the AS and a destination UPF entity of the Layer 3 of the AS, and
wherein a transceiver of the source UPF entity is configured to send the IP packets to the IP packet entity, so as to send the IP packets to a transceiver of the destination UPF entity through the IP packet entity.

12. The apparatus for the IP packet processing in the AS of claim 8, wherein the IP packet entity is in communication connection with one or more UPF entities, and the IP packet entity distributes the IP packets to the one or more UPF entities,
wherein a transceiver of each of the one or more UPF entities is configured to receive the IP packets distributed by the IP packet entity.

13. The apparatus for the IP packet processing in the AS of claim 8, wherein the IP packet entity establishes, modifies or releases the UPF entity corresponding to a control plane function entity of the Layer 3 through the control plane function entity,
wherein the transceiver is further configured to:
receive a signaling for IP connection establishment, a signaling for IP connection modification or a signaling for IP connection release from the control plane function entity corresponding to the UPF entity; and
establish, modify or release IP connections with the IP packet entity and the at least one function entity of Layer 2 of the AS according to the signaling for IP connection establishment, the signaling for IP connection modification or the signaling for IP connection release.

14.-15. (canceled)

16. A non-transitory computer-readable storage medium comprising instructions that, when executed by a computer, cause the computer to perform a method for Internet Protocol (IP) packet processing in an Access Stratum (AS), applied to a User Plane Function (UPF) entity of Layer 3 of the AS, comprising:
receiving, by the UPF entity of the Layer 3 of the AS, one or more IP packets from an IP packet entity and sending the IP packets to at least one function entity of Layer 2 of the AS; or
receiving, by the UPF entity of the Layer 3 of the AS, data packets or control packets from the function entity of the Layer 2 of the AS, and sending the data packets or the controls packet to the IP packet entity,
wherein the UPF entity of the Layer 3 of the AS, the IP packet entity and the function entity of the Layer 2 of the AS are function entities at a user equipment (UE) side or function entities at a network device side.

17. The non-transitory computer-readable storage medium of claim 16, wherein the method further comprises:
in response to failure of sending or reception of the IP packets, resending, by the UPF entity of the Layer 3 of the AS, the IP packets.

18. The non-transitory computer-readable storage medium of claim 16, wherein the method further comprise:
sorting, by the UPF entity of the Layer 3 of the AS, the data packets received from the function entity of the Layer 2 of the AS and sending the sorted IP packets to the IP packet entity.

19. The non-transitory computer-readable storage medium of claim 16, wherein the UPF entity of the Layer 3 of the AS comprises a source UPF entity of the Layer 3 of the AS and a destination UPF entity of the Layer 3 of the AS, and
wherein the method further comprises:
sending, by the source UPF entity, the IP packets to the IP packet entity, so as to send the IP packets to the destination UPF entity through the IP packet entity.

20. The non-transitory computer-readable storage medium of claim 16, wherein the IP packet entity is in communication connection with one or more UPF entities, and the IP packet entity distributes the IP packets to the one or more UPF entities,
wherein the method further comprises:
receiving, by the one or more UPF entities, the IP packets distributed by the IP packet entity.

21. The non-transitory computer-readable storage medium of claim 16, wherein the IP packet entity establishes, modifies or releases the UPF entity corresponding to a control plane function entity of the Layer 3 through the control plane function entity,
wherein the method further comprises:
receiving, by the UPF entity, a request for establishing, modifying or releasing an IP connection from the control plane function entity corresponding to the UPF entity; and
establishing, modifying or releasing, by the UPF entity, IP connections with the IP packet entity and the at least one function entity of Layer 2 of the AS according to the request for establishing, modifying or releasing the IP connection.

22. The non-transitory computer-readable storage medium of claim 21, wherein the method further comprises:
receiving, by a control plane function entity at the UE side, a signaling for IP connection establishment, a signaling for IP connection modification or a signaling for IP connection release from a control plane function entity at the network device side; or
sending, by the control plane function entity at the UE side, a request signaling for the IP connection establishment, a request signaling for the IP connection modification or a request signaling for the IP connection release to the control plane function entity at the network device side.
